(19) United States
(12) Patent Application Publication
(10) Pub. No.: US 2026/0285713 A1
(43) Pub. Date: Sep. 24, 2026

(54) APPLIANCE WITH SPLIT-ELECTRODE WATER FILTRATION ASSEMBLY

(71) Applicant: Haier US Appliance Solutions, Inc., Wilmington, DE (US)

(72) Inventors: Thomas Earl McKeehan, Jr., Crestwood, KY (US); Gregory Sergeevich Chernov, Louisville, KY (US); Amin Firouzi, Louisville, KY (US)

(21) Appl. No.: 19/084,867

(22) Filed: Mar. 20, 2025

(51) Int. Cl. C02F 1/461

(52) U.S. Cl. CPC C02F 1/46104; C02F 2001/46161; C02F 2201/004; C02F 2201/46135; C02F 2201/4616; C02F 2307/12

(57) ABSTRACT

An appliance and method for water filtration at an appliance are provided. The appliance and method position a conductive electrode in fluid communication with water upstream of a fluid inlet opening to a housing of a water filtration assembly. The conductive electrode is positioned outside of the housing of the water filtration assembly. The conductive electrode is electrically coupled to a power delivery system. A filtration media is positioned in the housing of the water filtration assembly and in serial fluid arrangement between the fluid inlet opening and a fluid outlet opening of the housing. The filtration media is electrically coupled to the power delivery system to form an electrolytic cell including the filtration media and the conductive electrode. A potential difference is selectively applied between the conductive electrode forming a first electrode and the filtration media forming a second electrode.

### FIELD OF THE INVENTION

The present subject matter relates generally to water filtration assemblies, and more particularly to water filtration assemblies having enhanced contaminant reduction performance.

### BACKGROUND OF THE INVENTION

Fresh water is a limited resource on the earth. Water shortage and contamination are among the top current issues in public health. With an increase in drinking water contaminant levels and the emergence of new contaminants, improvements in chemical and microbiological reduction performance of end point water treatment systems are desired to ensure consumer protection from potentially harmful exposure.

Water treatment using adsorptive media has been in practice since ancient times. Although modern Activated Carbon-based (AC) technologies allow the reduction of multiple health-related contaminants, further significant improvement of contaminant reduction performance is challenging. In most cases, an improvement of contaminant reduction performance requires an increase of physical dimensions of the product (a limiting factor for many residential applications, such as residential appliances), and/or a reduction of effective pore size (pore size reduction demands higher feed pressures or lowers flow rates which are also limiting factors for most residential applications). For most AC-based systems, the microbiological reduction is limited to relatively large protozoa, and most of these systems provide little to no protection from harmful bacteria and viruses.

Some contaminants in water are dissolved and cannot be mechanically removed. Rather, additives may be utilized to capture contaminants chemically. However, capacity for additives is limited, and high concentrations of contaminants can overwhelm the additives and affect the life of the filter. While mechanical filters will generally clog and inhibit water flow once the filter is expended, a filter using additives will continue to permit water to flow through even after the additives have lost their effectiveness at capturing contaminants.

Electrochemical structures at a filter can provide filtration benefits. However, electrochemical structures generally require positioning two or more electrodes within a filter housing, as well as circuitry and electrical leads, which makes such structures difficult or costly to manufacture and unavailable for appliances and consumer applications.

Accordingly, there is a continuous need for a water filtration assembly having enhanced contaminant reduction performance to address the aforementioned issues.

### BRIEF DESCRIPTION OF THE INVENTION

Aspects and advantages of the invention will be set forth in part in the following description, or may be obvious from the description, or may be learned through practice of the invention.

An aspect of the present disclosure is directed to an appliance including a manifold, a first electrode, and a filtration media forming a second electrode at a water filtration assembly. The manifold includes a water inlet and a water outlet, and a supply conduit is fluidly coupled to the water inlet to flow water to a water filtration assembly, and a return conduit is fluidly coupled to the water outlet to flow water from the water filtration assembly, A conductive first electrode is electrically coupled to a power delivery system. The conductive first electrode is positioned in fluid communication with water upstream of the water inlet. The water filtration assembly is downstream of the conductive first electrode. The water filtration assembly includes a housing having a fluid inlet opening fluidly coupled to receive water from the water inlet. The housing includes a fluid outlet opening fluidly coupled to the water outlet to provide water to the water outlet. The filtration media is positioned in the housing in serial fluid arrangement between the fluid inlet opening and the fluid outlet opening. The filtration media is electrically coupled to the power delivery system, and the power delivery system is configured to selectively deliver controlled voltage or current output to the first and second electrodes. The power delivery system is configured to selectively apply a potential difference between the conductive electrode forming the first electrode and the filtration media forming the second electrode.

An aspect of the present disclosure is directed to a method for water filtration at an appliance. The method includes positioning a conductive electrode in fluid communication with water upstream of a fluid inlet opening to a housing of a water filtration assembly. The conductive electrode is positioned outside of the housing of the water filtration assembly. The method includes electrically coupling the conductive electrode to a power delivery system. The method includes positioning, in the housing of the water filtration assembly, a filtration media in serial fluid arrangement between the fluid inlet opening and a fluid outlet opening of the housing. The method includes electrically coupling the filtration media to the power delivery system to form an electrolytic cell including the filtration media and the conductive electrode. The method includes selectively applying a potential difference between the conductive electrode forming a first electrode and the filtration media forming a second electrode.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 illustrates a front view of an embodiment of an appliance according to the present disclosure;

FIG. 2 illustrates a perspective view of the appliance shown in FIG. 1;

FIG. 3 illustrates a front view of the refrigerator appliance shown in FIG. 1 with doors in an open position;

FIG. 4 illustrates a simplified side view of an embodiment of a water filtration assembly secured within an appliance according to the present disclosure;

FIG. 5 illustrates a cross sectional side view of an embodiment of a water filtration assembly in accordance with aspects of the present disclosure;

FIG. 6 illustrates a perspective view of an electrically-driven module in accordance with aspects of the present disclosure;

FIG. 7 illustrates a perspective view of an embodiment of an electrically-driven module attached to a filtration media of the water filtration assembly of FIG. 5 in accordance with aspects of the present disclosure;

FIG. 8 illustrates a perspective view of an embodiment of a housing end cap of the water filtration assembly in accordance with aspects of the present disclosure;

FIG. 9A illustrates a detailed perspective cutaway view of the embodiment of the water filtration assembly of FIG. 5 in accordance with aspects of the present disclosure;

FIG. 9B illustrates a detailed perspective cutaway view of an embodiment of the water filtration assembly in accordance with aspects of the present disclosure;

FIG. 10 illustrates a cross sectional side view of an embodiment of a water filtration assembly in accordance with aspects of the present disclosure;

FIG. 11 illustrates a detailed cross sectional side view of the embodiment of the water filtration assembly of FIG. 10 in accordance with aspects of the present disclosure;

FIG. 12 illustrates a perspective view of an embodiment of the media block end cap of the water filtration assembly of FIG. 10 in accordance with aspects of the present disclosure; and

FIG. 13 provides a flowchart outlining steps of a method for water filtration at an appliance in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value, or values within ten percent greater or less than a full scale of a specified range. In this regard, for example, when used in the context of a distance, a distance of approximately 100 units includes up to 110 units. In another regard, for example, a distance between approximately 25 units and approximately 100 units includes a range from 18.5 units to 107.5 units.

Embodiments of a water filtration assembly addressing one or more of the aforementioned issues are provided. Embodiments herein include water filtration assemblies for an appliance, such as a refrigerator appliance, an icemaker appliance, a dishwasher appliance, a water purifier appliance, a beverage system appliance, or washing machine appliance, or other water-utilizing appliance or water-dispensing appliance. Aspects of the subject matter include methods for fabrication of a water filtration assembly having structures addressing one or more of the aforementioned issues.

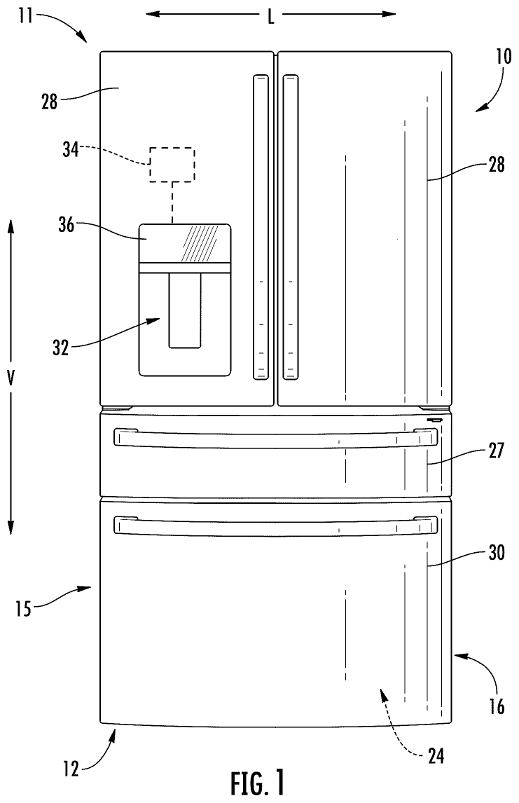

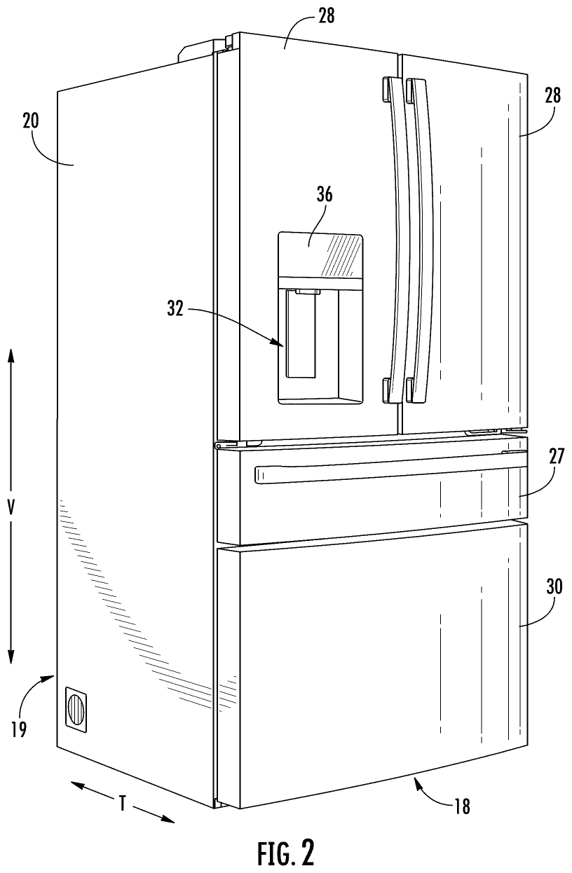

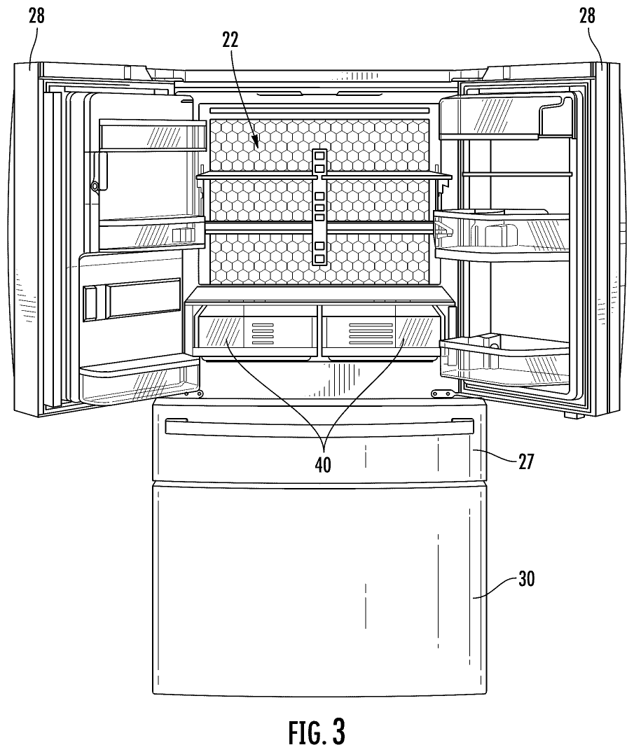

Referring now to the drawings, FIG. 1 illustrates a front view of an embodiment of a refrigerator appliance 10 according to the present disclosure. FIG. 2 illustrates a perspective view of the refrigerator appliance 10. FIG. 3 illustrates a front view of the refrigerator appliance 10 with refrigerator doors 28 in an open position. FIG. 1, in particular, illustrates the refrigerator appliance 10 extending between a top 11 and a bottom 12 along a vertical direction V. The refrigerator appliance 10 also extends between a first side 15 and a second side 16 along a lateral direction L. As shown in FIG. 2, a transverse direction T may additionally be defined perpendicular to the vertical and lateral directions V, L. The refrigerator appliance 10 extends along the transverse direction T between a front portion 18 and a back portion 19.

The refrigerator appliance 10 may include a cabinet or housing 20 (FIG. 2) defining an upper fresh food chamber 22 (FIG. 3) and a lower freezer storage chamber 24 arranged below the upper fresh food chamber 22 along the vertical direction V. An auxiliary food storage chamber may be positioned between the upper fresh food chamber 22 and the lower freezer storage chamber 24, e.g., along the vertical direction V. Because the lower freezer storage chamber 24 is positioned below the upper fresh food chamber 22, the refrigerator appliance 10 may be generally referred to as a bottom mount refrigerator. In the embodiment, the housing 20 may also define a mechanical compartment (not shown) for receipt of a sealed cooling system (not shown). Using the teachings disclosed herein, one of ordinary skill in the art will understand that the present technology can be used with other types of refrigerators (e.g., side-by-side) or a freezer appliance as well. Consequently, the description set forth herein is for illustrative purposes only and is not intended to limit the technology in any aspect.

Referring now particularly to FIG. 3, the refrigerator doors 28 may each be rotatably hinged to an edge of the housing 20 for accessing the upper fresh food chamber 22. It should be noted that while two refrigerator doors 28 in a “French door” configuration are illustrated, any suitable arrangement of doors utilizing one, two or more doors is within the scope and spirit of the present disclosure. A freezer door 30 may be arranged below the refrigerator doors 28 for accessing the lower freezer storage chamber 24. In the embodiment, the freezer door 30 is coupled to a freezer drawer (not shown) slidably mounted within the lower freezer storage chamber 24. An auxiliary door 27 may be coupled to an auxiliary drawer which may be slidably mounted within the auxiliary chamber.

Referring back to FIG. 1, operation of the refrigerator appliance 10 can be regulated by a controller 34 that is operatively coupled to a user interface panel 36. The user interface panel 36 may provide selections for user manipulation of the operation of the refrigerator appliance 10 to modify environmental conditions therein, such as temperature selections, etc. In some embodiments, the user interface panel 36 is proximate a dispenser assembly 32. In response to user manipulation of the user interface panel 36, the controller 34 may operate various components of the refrigerator appliance 10. Operation of the refrigerator appliance 10 may be regulated by the controller 34, e.g., the controller 34 may regulate operation of various components of the refrigerator appliance 10 in response to programming and/or user manipulation of the user interface panel 36.

The controller 34 may include a memory and one or more microprocessors, CPUs or the like, such as general or special purpose microprocessors operable to execute programming instructions or micro-control code associated with operation of the refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller(s) 34 as disclosed herein are capable of and may be operable to perform any methods and associated method steps as disclosed herein.

The controller 34 may be positioned in a variety of locations throughout the refrigerator appliance 10. In the illustrated embodiment, the controller 34 is located within the refrigerator doors 28. In such an embodiment, input/output (“I/O”) signals may be routed between the controller and various operational components of the refrigerator appliance 10. In one embodiment, the user interface panel 36 represents a general purpose I/O (“GPIO”) device or functional block. In one embodiment, the user interface panel 36 includes input components, such as one or more of a variety of electrical, mechanical or electro-mechanical input devices including rotary dials, push buttons, and touch pads. The user interface panel 36 may include a display component, such as a digital or analog display device designed to provide operational feedback to a user. For example, the user interface panel 36 may include a touchscreen providing both input and display functionality. The user interface panel 36 may be in communication with the controller via one or more signal lines or shared communication busses.

Using the teachings disclosed herein, one of skill in the art will understand that the present disclosure can be used with other types of refrigerators such as a refrigerator/freezer combination, side-by-side, bottom mount, compact, and any other style or model of refrigerator appliance. Accordingly, other configurations of the refrigerator appliance 10 could be provided, it being understood that the configurations shown in the accompanying figures and the description set forth herein are by way of example for illustrative purposes only.

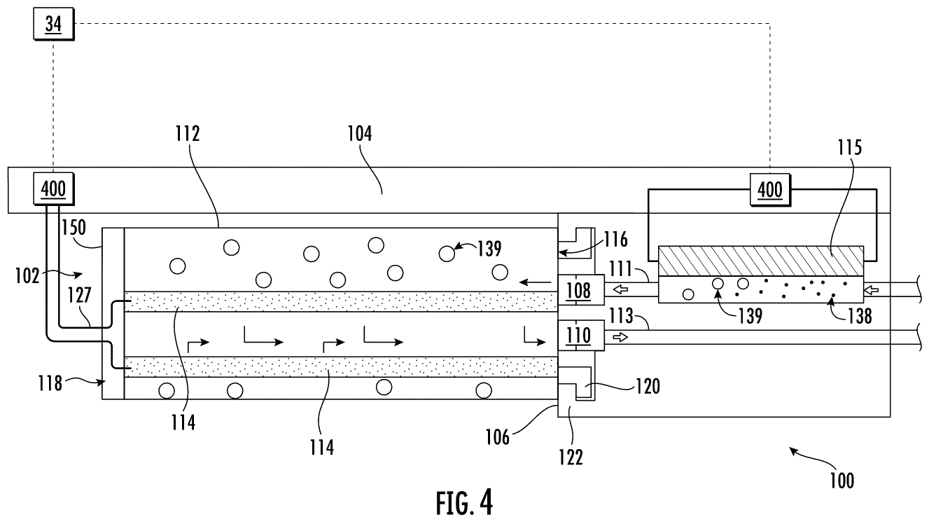

Referring now to FIG. 4, a simplified side view of an embodiment of an appliance 100 having a water filtration assembly 102 according to the present disclosure is illustrated. Appliance 100 may include, for example, one or more configurations of refrigerator appliance 10 such as depicted or described herein, or other suitable appliance. In particular, as shown, the appliance 100 includes at least one wall 104 having a manifold 106 secured thereto. Furthermore, as shown, the appliance 100 generally includes a water source (not shown) that provides water to and from the water filtration assembly 102, e.g., through the manifold 106 via a water inlet 108 and a water outlet 110. In addition, as shown, the appliance 100 may include a supply conduit 111 fluidly coupled to the water inlet 108 to provide water to the water filtration assembly 102, and a return conduit 113 fluidly coupled to the water outlet 110 to flow water from the water filtration assembly 102, such as further described herein. In various embodiments, water provided to the water filtration assembly 102 may generally include municipal water, household water, well water, or other water generally provided to a consumer appliance.

Referring to FIG. 4, the water filtration assembly 102 includes a filtration housing 112 and a filtration media 114. The filtration media 114 is positioned in serial fluid arrangement between the water inlet 108 and the water outlet 110. In the illustrated embodiment, the filtration housing 112 includes a first end 116 for securing the water filtration assembly 102 to the manifold 106 and a second end 118 for receiving at least a housing end cap including electrical or electronic components of the water filtration assembly 102. In various embodiments, the first end 116 of the filtration housing 112 may include one or more interlocking features 120 configured to secure the water filtration assembly 102 to corresponding interlocking features 122 of the manifold 106 positioned on the wall 104 of the appliance 100. In further embodiments, the first end 116 of the filtration housing 112 may be secured to the manifold 106 using any suitable means.

Referring still to FIG. 4, the appliance 100 includes the filtration system 102 having an electrochemical configuration to remove ions, particles, debris, or other particulates from water and the filtration media 114 by application of a potential difference between the filtration media 114 and a conductive electrode 115 each electrically connected as electrodes in fluid communication with water. The conductive electrode 115 may include any appropriate metal, conductive polymer, ceramic, carbon, or combinations thereof. The conductive electrode 115 is positioned in fluid communication with a flow of water upstream of the water inlet 108, such as in fluid communication with the supply conduit 111. The conductive electrode 115 upstream of the filtration system 102 precipitates the contaminants at the water. The water is provided downstream to the filtration system 102 through the water inlet 108 and is filtered through the filtration media 114. The filtration media 114 is electrically coupled to a power supply system or power delivery system 400 through electrical wire leads 127 extending through the housing 112 or housing end cap 150, such as further described herein. The conductive electrode 115 forms a first or upstream electrode and the filtration media 114 forms a second or downstream electrode at which contaminants are captured inside the filtration media 114, or at an outer surface thereof.

The filtration system 102 includes filtration media 114 and conductive electrode 115 configured as a split electrolytic cell having a cathode and an anode electrode separated from one another inside and outside the housing 112. The power delivery system 400 may be configured to supply or deliver controlled voltage or current output at the electrolytic cell. The controller 34 may be configured to selectively apply voltage or current at the electrolytic cell based on a period of time or a flow characteristic threshold, or, additionally, configured to receive or transmit signals corresponding to flow characteristic, or determine quantity or quality of flow across the filtration medium.

Embodiments of the filtration system 102 may improve filtration performance at a mechanical structure, such as the filtration media 114, by applying a potential difference between the first and second electrodes. Applying the potential difference may perform an oxidation-reduction (redox) reaction to form coagulated particles of dissolved particulates from the fluid. The coagulated particles may be captured and precipitated on or in the filtration media 114, such as a carbon or carbon-based material, or polymer hydrogel including a conductive particle filler, matrix, or other material. As precipitated particles accumulate on the filtration media 114, the flow characteristic corresponding to a quantity or quality of flow across the filter medium may decrease (e.g., a flowrate of fluid across the filter medium may decrease). Selectively applying the potential difference may improve trapping of the coagulated particles at the filtration media 114 and improve water filtration. Embodiments of the appliance 100 and water filtration system 102 may permit splitting the electrolytic cell between a substantially permanent electrode (e.g., conductive electrode 115) and an electrode that can be included with a replaceable or disposable filter housing (e.g., filtration media 114).

In various embodiments, the controller 34 is operably coupled to the power delivery system 400 to command, at the power delivery system 400, applying a potential difference between the conductive electrode 115 and the filtration media 114, such as may convert harmful contaminants 138 into larger particles 139. The larger particles 139 are more easily captured through mechanical structures, such as the filtration media 114. Applying the potential difference may include controlling a voltage or a current at the electrolytic cell.

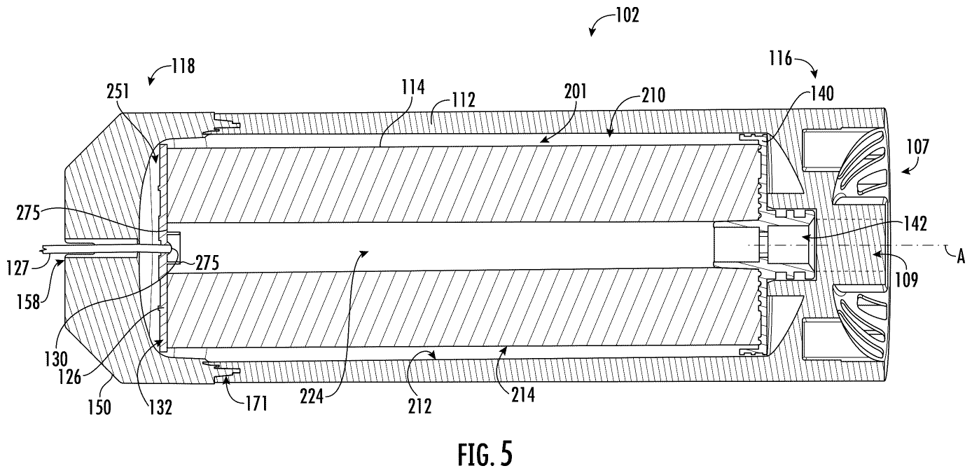

Referring now to FIGS. 5-8 and FIGS. 9A-9B, embodiments of the water filtration assembly 102 include a filtration housing 112 having an inner surface 212 adjacent to a housing internal volume 210, a fluid inlet opening 107, a fluid outlet opening 109, and a second or distal end 118, such as may be distal to the first end 116. A filtration media 114 is positioned within the housing internal volume 210. A first flow passage 201 extends in fluid communication from the fluid inlet opening 107. The first flow passage 201 is at least partially formed between the inner surface 212 of the housing 112 and an outer surface 214 of the filtration media 114. The filtration media 114 includes a media block internal volume 224 fluidly downstream of a porous structure, such as further described herein. The filtration media 114 includes the porous structure permitting fluid flow from the first flow passage 201 to the media block internal volume 224.

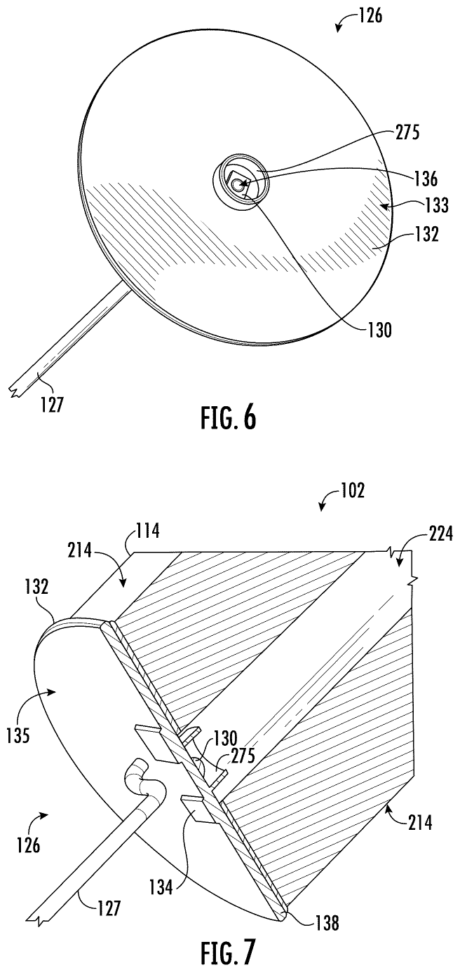

An electrically-driven module 126 includes a circuit board 132 configured to attach directly to the filtration media 114. Referring not FIGS. 6-7, the circuit board 132 includes a first face 133 at which the filtration media 114 abuts. The circuit board 132 includes a second face 135 opposite of the first face 133. The first face 133 includes a coating layer 138 at the first face 133, the second face 135, or both, or, additionally, one or more sides therebetween. The coating layer 138 may include a waterproof sealant, such as, but not limited to, a silicone or plastic substrate, a polytetrafluoroethylene (PTFE) substrate, or other appropriate food grade sealant. In various embodiments, t coating layer 138 at the first face 133 includes an adhesive configured to join the filtration media 114 to circuit board 132 at the first face 133. In some embodiments, the coating layer 138 configured as a food grade electronics sealant is applied to seal electronic components 134 and sensors 130, and the adhesive is applied to join the filtration media 114 to the circuit board 132. In still various embodiments, the coating layer 138 forms a thermal barrier protecting the circuit board 132, electronic components 134, sensors 130, or other electrical or electronic busses, connectors, etc.

An electric wire lead 127 extends through a lead egress opening 158 extending through a housing end cap 150. The sensor 130 is positioned in operable arrangement with fluid received at or downstream of the media block internal volume 224.

The housing end cap 150 is receivable at the distal end 118 of the housing 112. A plenum 251 may be formed between the housing end cap 150 and the circuit board 132. In an exemplary embodiment of a method for fabrication, the electrically-driven module 126 including the circuit board 132 carrying one or more sensors 130, electronic components 134 (e.g., circuits, switches, processors, etc.), and electric wire lead 127 is mated to the filtration media 114. The filtration media 114 and attached circuit board 132 are positioned in the housing internal volume 210. The electric wire lead 127 is routed through the lead egress opening 158 extending along a centerline axis A (FIG. 5).

Referring to FIG. 5, in various embodiments, a media end cap 140 is configured to receive the filtration media. The media end cap 140 is positioned distal to the circuit board 132, such as distal along the centerline axis A from the housing end cap 150. The media end cap 140 includes a fluid outlet opening 142 in fluid communication with the media block internal volume 224 to egress a flow of filtered water from the housing internal volume 210. The fluid outlet opening 142 is positioned in fluid communication with fluid outlet opening 109, such as to egress filtered and/or sterilized water from the water filtration assembly 102 to return conduit 113 (FIG. 4).

Embodiments of the filtration media 114 described herein may be constructed of any suitable material, such as activated carbon (AC), or any other conductive filtration media material. In such embodiments, the adsorptive, catalytic, and structural properties of AC make it effective at capturing contaminants including particulates, volatile organic compounds (VOCs), metals, pharmaceuticals, pharmaceutical break-down products, per-and polyfluoroalkyl substances (PFASs), disinfectants, disinfectant by-products, and other contaminants. In another embodiment, the filtration media 114 may be constructed of a zeolite, a non-woven material, a textile, an immobilized granulated media, an ion exchange resin, a membrane, a hollow fiber, and/or a composite of natural or synthetic materials.

In some embodiments, the filtration media 114 includes a polymer hydrogel including a water-permeable structure cross-linked hydrophilic polymer network. The polymer hydrogel filtration media 114 may include a membrane at which a plurality of nanoparticles may be included or embedded. The nanoparticles may be configured to target desired contaminants, such as to enhance filtration of certain contaminants more than others. Polymer hydrogels may include natural polymers, synthetic polymers, or combinations thereof, including, but not limited to, hyaluronic acid, chitosan, heparin, alginate, gelatin, fibrin, polyvinyl alcohol, polyethylene glycol, sodium polyacrylate, acrylate polymers, polyethylene glycol (PEG), polyacrylate, or polyvinylpyrrolidone (PVP), or combinations thereof.

In still various embodiments, the circuit board 132 includes a sidewall 275 at the first face 133, such as forming a cylindrical barrier around the sensor 130. The sidewall 275 may be attached to the circuit board 132 similarly as described regarding attaching the filtration media 114 to the circuit board 132. The sidewall 275 may form a cylindrical barrier extending into the media block internal volume 224. In some embodiments, the sidewall 275 provides a positioning surface, such as may center the filtration media 114 relative to the circuit board 132.

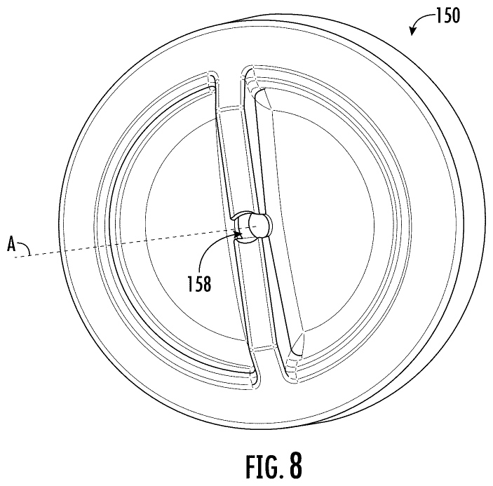

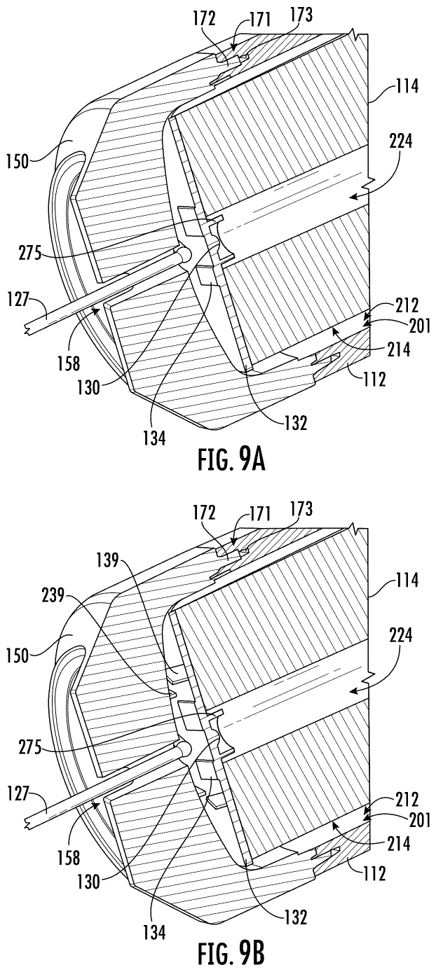

Referring to FIG. 5, FIG. 8, and FIGS. 9A-9B, in various embodiments, housing end cap 150 includes the lead egress opening 158 through which the electric wire lead 127 is permitted to extend to the circuit board 132, sensor 130, and electronic components 134. The lead egress opening 158 includes a passage extending through the housing end cap 150, such as along the centerline axis A along which the housing 112 extends along a major axis.

In various embodiments, the lead egress opening 158 extends substantially along the centerline axis A, such as depicted in FIG. 5. As described herein, embodiments of the water filtration assembly 102 and methods for fabrication depicted and described herein may facilitate or permit routing and egressing of electric wire leads 127 such as described herein, and furthermore, while sealing electrically-driven modules 126 and fluids while providing desired interaction between sensor signals and water within the water filtration assembly 102.

Referring to FIG. 5, in various embodiments, the water filtration assembly 102 includes a first mating interface 171 at which the housing end cap 150 couples to the housing 112. The plenum 251 is formed between the housing end cap 150 and the circuit board 132. The first mating interface 171 may include a first wall 172 and a first slot 173 at which the first wall 172 is received. In an embodiment, the housing end cap 150 includes the first wall 172, and the housing 112 includes the first slot 173 at which the first wall 172 is received. In other embodiments, the housing 112 includes the first wall 172 and the housing end cap 150 include the first slot 173. The first wall 172 may form a raised wall extending substantially or fully circumferentially (e.g., relative to centerline axis A), and the first slot 173 may form a groove, indentation, or cavity at which the first wall 172 is receivable.

In a method for fabrication of the water filtration assembly 102, housing 112 and housing end cap 150 are joined together at the first mating interface 171 using a friction joining process, such as a spin welding process. One of the housing 112 or housing end cap 150 may be fixed or stationary as the other of the housing 112 and housing end cap 150 is rotated and pressed (e.g., along centerline axis A) together. Heat and friction at the first mating interface 171 bond the first wall 172 at the housing end cap 150 or housing 112 to the other of the housing 112 or housing end cap 150 at the first slot 173. As such, the separate housing 112 and housing end cap 150 components are joined at the first mating interface 171, such as may provide a fluidly sealed interior volume. Additionally, electric wire lead(s) 127 extending along the centerline axis A through the housing end cap 150 may permit rotation of the housing end cap 150 without having the wire lead 127 rotate.

In a method for fabrication, lead egress opening 158 receives a sealant, such as an epoxy, hot-melt adhesive, or molten plastic, or other extrudable material, after joining the housing end cap 150 to the housing 112. Sealant may flow from the lead egress opening 158 into the plenum 251. Openings (e.g., openings 107, 109) at the water filtration assembly 102 may provide venting to atmospheric pressure, such as to permit flow of sealant from outside of the housing end cap 150 to the plenum 251.

Referring to FIG. 9B, in some embodiments, a wall 139, 239 extends into the plenum 251 (FIG. 5) from the housing end cap 150, the circuit board 132, or both. One or both of walls 139, 239 may be positioned at the plenum 251. Walls 139, 239 extending toward one another at the plenum 251 may form a labyrinthine or tortious path along which sealant may flow at the plenum 251 from the lead egress opening 158. For instance, walls 139, 239 may be radially adjacent to one another from the centerline axis A. Walls 139, 239 may extend substantially circumferentially around centerline axis A and opening 158 at the plenum 251. Walls 139, 239 may be positioned physically separate from one another, such that rotation of the housing end cap 150 relative to the circuit board 132 (or vice versa) does not rub walls 139, 239 to one another.

In various embodiments, the water filtration assembly 102 is configured to receive a flow of water from the manifold 106 through water inlet 108 (FIG. 4) and into housing 112 through fluid inlet opening 107 and entering the first flow passage 201. The first flow passage 201 generally extends upstream from the filtration media 114. Water is permitted to flow from the first flow passage 201, such as from between the inner surface 212 of the housing 112 and the filtration media 114, through the porous structure of the filtration media 114, such as may remove sediment and undesired matter from the water before flowing to the media block internal volume 224. As further described herein, sensor 130 is configured to operably communicate with water received from the filtration media 114, such as to purify, sterilize, irradiate, or sense a physical or flow property of the water.

It should be appreciated that structures joined at the first mating interface 171 form and include a friction joining structure, friction weld structure, or spin weld structure. As such, the first mating interface 171 includes the friction weld structure at the housing end cap 150 and the housing 112.

Embodiments of the water filtration assembly 102 and method for fabrication provided herein may permit fabrication of positioning of electrically-driven modules and seals such as described herein. It should be appreciated that novel structures and methods provided herein may promote or permit construction in which direct application of welds, brazes, sealants, adhesives, or seals may be impermissible, such as lacking direct line-of-sight.

Embodiments of the water filtration assembly 102 and method for fabrication provided herein may permit more proximate positioning of water relative to a sensor, or stated differently, more proximate positioning of a sensor relative to water, such as may improve intensity of radiation provided to the water for purification, improve temperature, pressure, turbidity, or other sensing of water, or other desired interactions between the sensor and the water within the filtration assembly.

Referring to FIGS. 5-8 and FIGS. 9A-9B, water provided proximately to the electrically-driven device 126 at the media block internal volume 224 may promote or enhance operability and interaction of the electrically-driven device 126, or signals, emissions, or transmission therefrom, with the water.

In various embodiments, the electrically-driven module 126 includes the electric wire lead 127 extending through the housing end cap 150. The electrically-driven module 126 includes the sensor 130 configured to transmit, receive, or both, a signal. For instance, the sensor 130 may be configured to transmit, receive, or both, an electromagnetic signal. In some embodiments, the electrically-driven module 126 includes the sensor 130 including an electromagnetic radiation module configured as an electromagnetic radiation source positioned adjacent to the filtration media 114. The electrically-driven module 126 and sensor 130 may include an electromagnetic radiation emitter configured to emit germicidal radiation. In various embodiments, the electrically-driven module 126 and sensor 130 include the electromagnetic radiation module configured as a UVC module including an electromagnetic radiation emitter that emits germicidal radiation via an ultraviolet-C (UVC) emitting diode. Thus, in such embodiments, the sensor 130 is configured as a UVC emitting diode. In further embodiments, the sensor 130 may include a blue light emitting diode (LED), an ultraviolet-A (UVA) emitting diode, an ultraviolet-B (UVB) emitting diode, or similar, or combinations thereof.

In still various embodiments, the sensor 130 configured as an electromagnetic radiation module is positioned adjacent to water received from the filtration media 114. The sensor 130 configured as an electromagnetic radiation module is positioned within sidewall 275, such as to emit signals from the sensor 130 through the passage formed at sidewall 275 and directly into the media block internal volume 224, such as to sterilize water filtered from the filtration media 114.

In some embodiments, sensor 130 is configured to measure an amount of light scatted by solids (e.g., particulates) in the water, such as total suspended solids (TSS) or total dissolved solids (TDS). The measure of amount of light scattered by solids in the water may measure turbidity (e.g., cloudiness or haziness) of the water. The electrically-driven module 126 and sensor 130 may include light-emitting sources such as described above, or additionally, photo detectors, lenses, light-blocking and light-admitting structures. As such, embodiments of the electrically-driven module 126 and sensor 130 may include a turbidity sensor.

In still various embodiments, electrically-driven module 126 and sensor 130 may generally include a sensor configured to transmit and/or receive signals for measuring or determining an amount or concentration of solids, fluid pressure, or flowrate.

In various embodiments, the electrically-driven device 126 includes a lens 136 (FIG. 6) arranged adjacent to the sensor 130 configured as an electromagnetic radiation emitter such that the emitted radiation passes through the lens before irradiating the media block internal volume 224. The lens may be made of borosilicate glass or another suitable material transparent to the wavelength of the electromagnetic radiation from the emitter. In some embodiments, the lens is configured to modify the direction of the electromagnetic radiation rays. For example, in an embodiment, the lens may be configured to reduce the rays into a narrow beam and increase the radiation intensity within the media block internal volume 224.

In some embodiments, the electrically-driven device 126 includes a collimating lens 136 arranged adjacent to the sensor 130 configured as an electromagnetic radiation emitter such that the emitted radiation light can pass through the collimating lens before irradiating the media block internal volume 224. For example, in an embodiment, the collimating lens is configured to provide a radiation beam with a nearly constant correction into the media block internal volume 224, such as may improve consistency and efficiency of microbial deactivation.

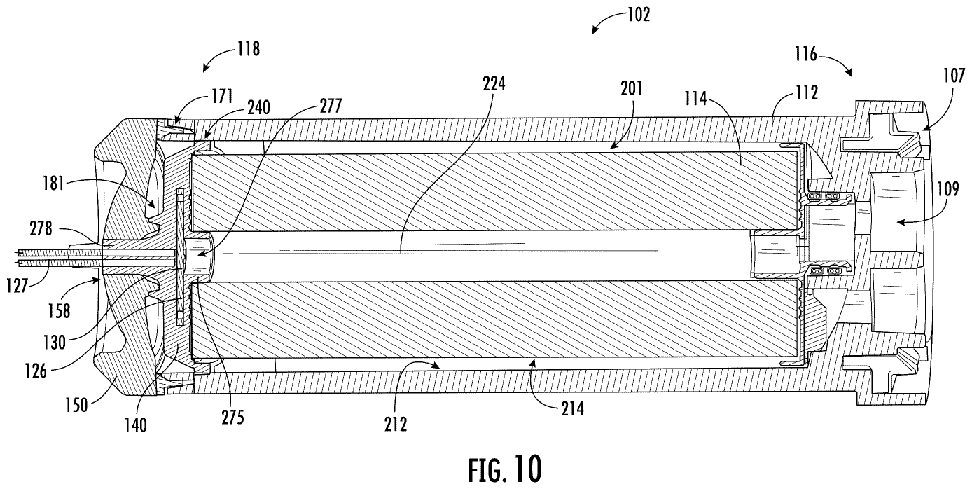

Referring now to FIGS. 10-12, an embodiment of the water filtration system 102 is provided. The embodiments depicted in FIGS. 10-12 include the housing 112, filtration media 114, housing end cap 150 and first mating interface 171, and electrical wire leads 127 extending through the housing end cap 150 such as described in regard to the embodiments above.

In FIGS. 10-12, the filtration system 102 further includes a media block end cap 140 at which the filtration media 114 is positioned adjacent. The electrically-driven module 126 including the sensor 130 is housed at the media block end cap 140.

In various embodiments, the media block end cap 140 and the housing 112 together include an anti-rotation interface 240 configured to inhibit rotation of the media block end cap 140 relative to the housing 112. In some embodiments, the anti-rotation interface 240 includes a key interface including a key 244 and slot 246 at which the key 244 is receivable. In an embodiment, the media block end cap 140 includes the key 244, and the housing 112 includes the slot 246 at which the key 244 is received. In other embodiments, the housing 112 includes the key 244 and the media block end cap 140 include the slot 246. The key 244 may include a castellation, a crenelation, a tooth, a raised wall, or other raised surface extendable into the slot 246. The slot 246 may include an indentation, curve, or other geometry, such as at the housing 112, into which the key 244 is receivable. In various embodiments, the anti-rotation interface 240 at the housing 112 is positioned at the inner surface 212 of housing 112. As such, the media block end cap 140 couples to the housing 112 at the inner surface 212 of the housing 112.

In various embodiments, the key 244 and slot 246 extend substantially co-directional to an axis (e.g., centerline axis A) along which the housing 112 or the housing end cap 150 may be rotated, or extend substantially along a direction of rotation thereof, in a friction joining process, such as a spin welding process. As such, the key 244 extending into the slot 246 may inhibit rotation of the media block end cap 140 relative to the housing 112.

Additionally, coupling or inserting the media block end cap 140 to the housing 112 may be performed or limited to articulation substantially along the axis (e.g., axis A) along which the housing 112 or the housing end cap 150 may be rotated in the friction joining process. In some embodiments, the key interface may include a fit, such as a press fit, interference fit, or other interaction between the key 244 and slot 246, to limit movement of the media block end cap 140 relative to the housing 112 along the axis along which the media block end cap 140 is inserted into the housing 112 (e.g., centerline axis A).

Referring briefly to FIG. 10, in some embodiments, the media block end cap 140 includes a base wall 274 at which the filtration media 114 is receivable. An outer perimeter wall 273 may extend from the base wall 274, such as substantially co-directional to axis A. For instance, the outer perimeter wall 273 extends substantially co-directional to the axis A from the base wall 274 and toward the first end 116 of the water filtration assembly 102. Walls 273 and 274 may extend substantially radially from axis A. In some embodiments, such as further described herein, a key 244 extends from outer perimeter wall 273 substantially co-directional to axis A. In still various embodiments, a sidewall 275 extends from the base wall 274, such as forming a wall extending around an end cap opening 242 and forming a passage, such as further described herein. For instance, the sidewall 275 may form a cylindrical barrier extending into the media block internal volume 224. As described in various embodiments herein, the sidewall 275 may provide a passage 277 at which the sensor 130 is positioned or a conduit extends through the media block end cap 140.

As described herein, electrical wire leads 127 extend substantially along the centerline axis A through a central opening 158 at the housing end cap 150. The housing end cap 150 and the media block end cap 140 each include an opening through which the electric wire lead 127 is permitted to extend to an exterior of the housing end cap 150. The lead egress opening 158 at the housing end cap 150 may form a passage permitting the electric wire lead 127 to extend therethrough. The media block end cap 140 may include a neck 278 configured to extend into the housing end cap 150 at the lead egress opening 158. The neck 278 include a lead egress opening 279 through which the electric wire lead 127 extends from the media block end cap 140 and through the housing end cap 150 to an exterior of the water filtration assembly 102.

In various embodiments, the water filtration assembly 102 includes a second mating interface 181 at which the housing end cap 150 couples to the media block end cap 140. In some embodiments, plenum 250 is formed between the housing end cap 150 and the media block end cap 140, and radially inward of the second mating interface 181. In still various embodiments, plenum 251 is formed radially between the first mating interface 171 and the second mating interface 181. In various embodiments, the second mating interface 181 is positioned radially outward of the centerline axis A. The second mating interface 181 may include a second wall 182 and a second slot 183 at which the second wall 182 is received. In an embodiment, the housing end cap 150 includes the second wall 182, and the media block end cap 140 includes the second slot 183 at which the second wall 182 is received. In other embodiments, the media block end cap 140 includes the second wall 182 and the housing end cap 150 includes the second slot 183. The second wall 182 may form a raised wall extending substantially or fully circumferentially (e.g., relative to centerline axis A), and the second slot 183 may form a groove, indentation, or cavity at which the second wall 182 is receivable.

Referring to FIG. 12, in some embodiments, the media block end cap 140 includes a second perimeter wall 276 extending from the base wall 274, such as substantially co-directional to axis A. For instance, the second perimeter wall 276 extends substantially co-directional to the axis A from the base wall 274 and toward the second end 118 of the water filtration assembly 102, such as opposite along the direction of axis A from the first or outer perimeter wall 273. The second perimeter wall 276 and second wall 182 may together form a tongue and key, key and slot, or male/female interface at which a member is received at a slot.

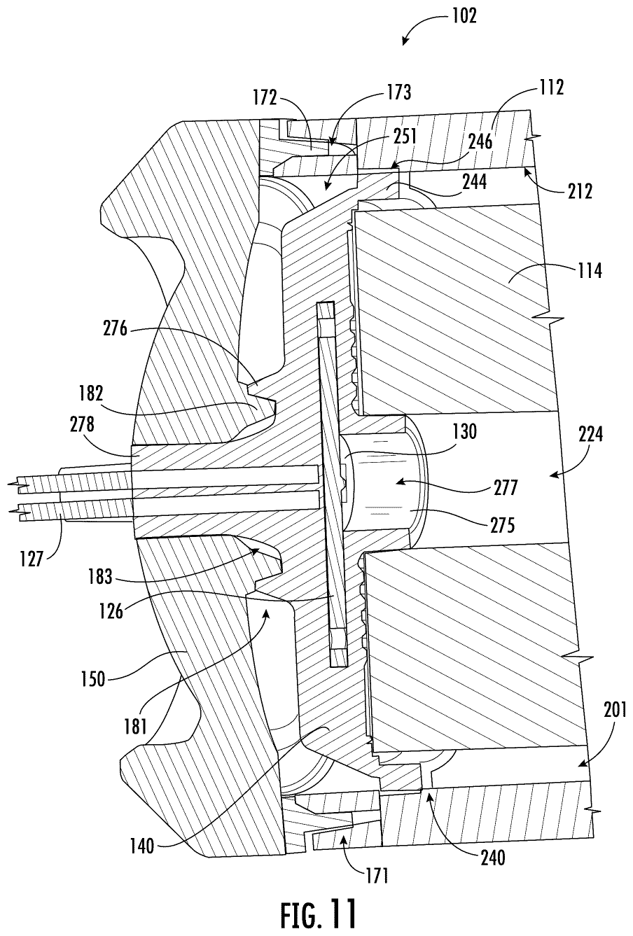

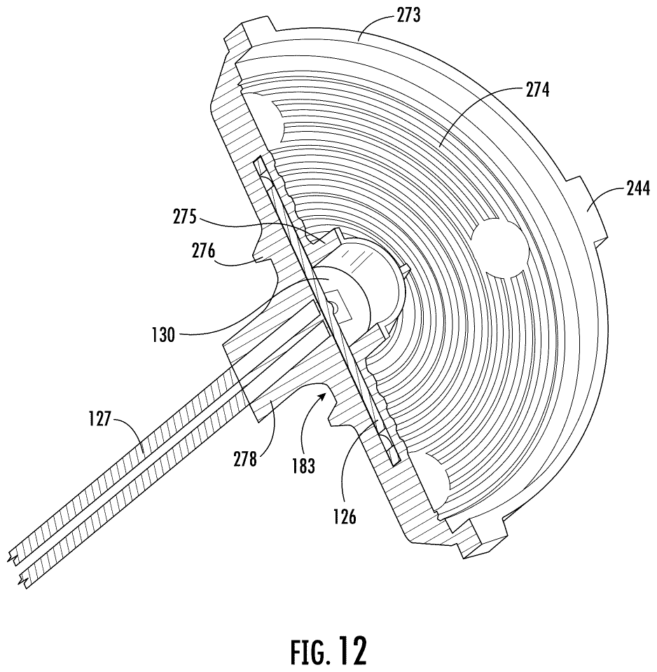

As such, referring to FIGS. 10-11, the second mating interface 181 provides a seal interface sealing the plenum 250 formed between the housing end cap 150 and the media block end cap 140, and an end cap opening 242 provides fluid communication between the plenum 250 and the media block internal volume 224. Furthermore, the second mating interface 181 may provide a sealed interface between the media block end cap 140 and the housing end cap 150, such as may remove a need for applying a seal body, adhesive, or sealant to fluidly seal the plenum 250 from pre-treated fluid as described herein. As such, the second mating interface 181 may facilitate sealing and mitigate or eliminate a potential for improper or incomplete application of adhesive or sealant, damage to a seal body, or insufficient sealing contact of a sealant or seal body between sealing surfaces.

In a method for fabrication of the water filtration assembly 102, the first wall 172 is positioned into the first slot 173 such as provided regarding the housing 112 and housing end cap 150. Additionally, the second wall 182 is positioned into the slot 183 such as provided regarding the housing end cap 150 and the media block end cap 140. A friction joining process, such as a spin welding process, is performed such as may substantially simultaneously bond the housing end cap 150 at the first mating interface 171 and the housing end cap 150 to the media block end cap 140 at the second mating interface 181. As such, the separate housing 112 and housing end cap 150 components are joined at the first mating interface 171, and the separate media block end cap 140 and housing end cap 150 are joined at the second mating interface 181, such as may provide a fluidly sealed interior volume including the plenum 250 and the housing internal volume 210.

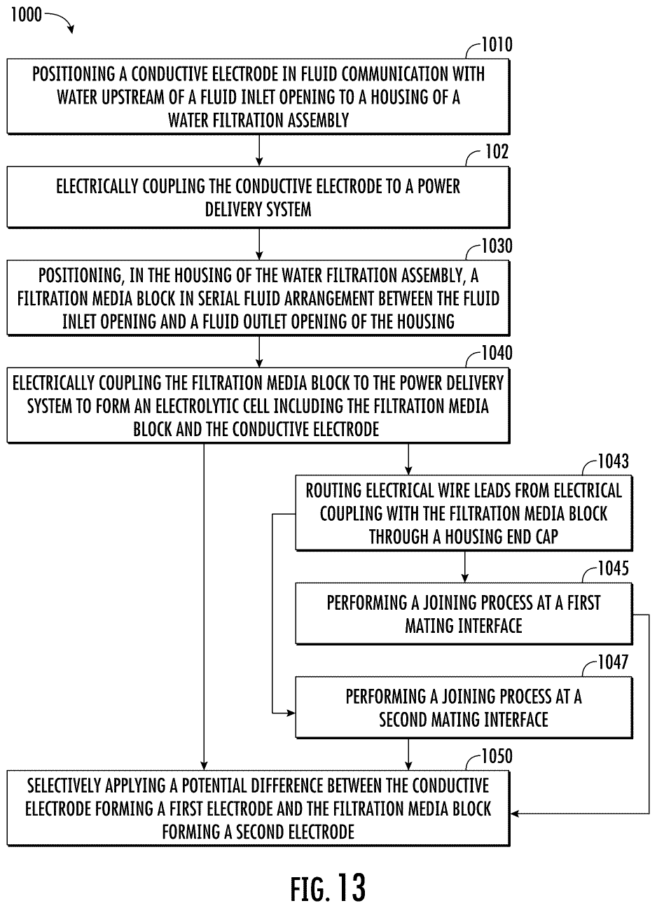

Referring now to FIG. 13, a flowchart outlining steps of a method for water filtration at an appliance (hereinafter, “method 1000”) is provided. Steps of the method 1000 may include components, structures, arrangements, and steps for fabrication such as depicted and described in regard to FIGS. 1-12 for the appliance 10 and water filtration assembly 102.

Method 1000 includes at 1010 positioning a conductive electrode (e.g., electrode 115) in fluid communication with water upstream of a fluid inlet opening (e.g., opening 107, 108) to a housing (e.g., housing 112) of a water filtration assembly (e.g., water filtration assembly 102), the conductive electrode positioned outside of the housing of the water filtration assembly.

Method 1000 includes at 1020 electrically coupling the conductive electrode to a power delivery system (e.g., power delivery system 400).

Method 1000 includes at 1030 positioning, in the housing of the water filtration assembly, a filtration media (e.g., filtration media 114) in serial fluid arrangement between the fluid inlet opening and a fluid outlet opening (e.g., opening 109, 110) of the housing.

Method 1000 includes at 1040 electrically coupling the filtration media to the power delivery system to form an electrolytic cell including the filtration media and the conductive electrode.

In various embodiments, method 1000 includes at 1043 routing electrical wire leads (e.g., wire leads 127) from electrical coupling with the filtration media through a housing end cap (e.g., end cap 150). Routing the electrical wire leads may include routing the leads along a centerline axis corresponding to an axis of rotation for a friction joining procedure (e.g., a spin weld procedure). In still various embodiments, method 1000 includes at 1045 performing a joining process at a first mating interface (e.g., interface 171), or furthermore, at 1047, performing a joining process at a second mating interface (e.g., interface 181), such as described herein. Method 1000 at 1045 and 1047 may be performed concurrently, such as performing the joining processes concurrently via a double-spin weld process at the first and second mating interfaces, to desirably seal the housing, promote filtration, fluidly segregate filtered and un-filtered water, or fluidly segregate electrical and electronic components from water.

Method 1000 includes at 1050 selectively applying a potential difference between the conductive electrode forming a first electrode and the filtration media forming a second electrode. Method 1000 at 1050 may include applying the potential difference to perform an oxidation-reduction (redox) reaction to form coagulated particles of dissolved particulates from the water. The coagulated particles may be captured and precipitated on or in the filtration media.

Embodiments of the method 1000 permit splitting the electrolytic cell between a substantially permanent electrode (e.g., conductive electrode) and an electrode that can be included with a replaceable or disposable filter housing (e.g., filtration media).

Embodiments of the appliance 100, filtration assembly 102, and method 1000 for fabrication and filtration depicted and described herein may facilitate routing electrical wire leads 127 to an electrode positioned in a sealed volume, such as within the housing 112, while providing fluid separation and sealing for water filtration, or furthermore, and water sterilization. Embodiments of the appliance 100 including the filtration assembly 102 may permit a split-electrode arrangement that is more compact and manufacturable, while furthermore permitting, facilitating, and improving filtration and sterilization.

Embodiments of the appliance 100, water filtration assembly 102, and method 1000 including the split-electrode system provided herein permits placement of an electrode inside of a consumable filter housing, with the filtration media acting as a consumable electrode. The conductive electrode is positioned outside of the housing and may act as a permanent electrode. The split-electrode system allows for creating an electrochemical redox reaction between the pair of electrodes to convert harmful contaminants 138 into larger particles 139. The larger particles 139 are more easily captured through mechanical structures. Embodiments provided herein may provide a simpler, effective, and more cost-effective solution for removing electrochemical contaminant removal.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed:

1. An appliance, the appliance comprising:
a manifold comprising a water inlet and a water outlet, wherein a supply conduit is fluidly coupled to the water inlet to flow water to a water filtration assembly, and wherein a return conduit is fluidly coupled to the water outlet to flow water from the water filtration assembly;
a conductive electrode electrically coupled to a power delivery system, the conductive electrode positioned in fluid communication with water upstream of the water inlet, and wherein the water filtration assembly is downstream of the conductive electrode; and
the water filtration assembly comprising a housing comprising a fluid inlet opening fluidly coupled to receive water from the water inlet, and wherein the housing comprises a fluid outlet opening fluidly coupled to the water outlet to provide water to the water outlet, and wherein the filtration media is positioned in the housing in serial fluid arrangement between the fluid inlet opening and the fluid outlet opening,
wherein the filtration media is electrically coupled to the power delivery system, the power delivery system configured to selectively deliver controlled voltage or current output to the conductive electrode and the filtration media, and wherein the power delivery system is configured to selectively apply a potential difference between the conductive electrode forming a first electrode and the filtration media forming a second electrode.

2. The appliance of claim 1, wherein the water filtration assembly comprises:
an electrically-driven module comprising a circuit board electrically coupled to the filtration media, wherein an electric wire lead extends from the circuit board through a lead opening and a lead passage at a housing end cap attachable to the housing.

3. The appliance of claim 2, wherein the housing end cap comprises the lead opening and the lead passage extending along a centerline axis mutual to the housing end cap and the housing.

4. The appliance of claim 3, wherein the water filtration assembly comprises a first mating interface at which the housing end cap couples to the housing, the first mating interface comprising a first wall and a first slot at which the first wall is received.

5. The appliance of claim 2, wherein the circuit board is coupled to the filtration media via an adhesive layer positioned between the circuit board and the filtration media, and wherein the circuit board comprises an electronic component configured to deliver voltage or current from the electric wire lead to the filtration media.

6. The appliance of claim 5, wherein the circuit board comprises a coating layer positioned at a first face adjacent to the filtration media, the coating layer comprising a food-grade sealant.

7. The appliance of claim 5, wherein the adhesive layer is configured to join a cylindrical sidewall to the circuit board at a first face adjacent to the filtration media, wherein the filtration media is positioned abutting the circuit board such that a media block internal volume extends from a passage formed from the cylindrical sidewall, and wherein the media block internal volume extends in fluid communication to the fluid outlet opening of the housing.

8. The appliance of claim 2, the water filtration assembly comprising a media block end cap at which the circuit board is positioned, wherein the media block end cap and the housing together comprise an anti-rotation interface configured to inhibit rotation of the media block end cap relative to the housing.

9. The appliance of claim 8, the water filtration assembly comprising:
a first mating interface at which the housing end cap couples to the housing, the first mating interface comprising a first wall and a first slot at which the first wall is received; and
a second mating interface at which the housing end cap couples to the media block end cap, wherein the second mating interface comprises a second wall and a second slot at which the second wall is received.

10. The appliance of claim 9, wherein the first mating interface and the second mating interface each comprise a friction weld structure, wherein the first mating interface comprises the friction weld structure at the housing end cap and the housing, and wherein the second mating interface comprises the friction weld structure at the housing end cap and the media block end cap.

11. The appliance of claim 8, wherein the circuit board comprises an electronic component configured to deliver voltage or current from the electric wire lead to the filtration media, wherein the circuit board and the electronic component is positioned at the media block end cap at which the filtration media abuts.

12. The appliance of claim 11, wherein the media block end cap and the housing end cap each comprise a lead opening through which the electric wire lead extends to the circuit board positioned at the media block end cap.

13. The appliance of claim 12, wherein the media block end cap and the housing end cap each comprise the lead opening positioned through a centerline axis mutual to the media block end cap, the housing end cap, and the housing.

14. The appliance of claim 8, wherein the media block end cap comprises a neck extending into the housing end cap, wherein the lead opening is positioned at the neck.

15. The appliance of claim 14, wherein the second mating interface is positioned radially outward of the neck from the centerline axis, the second mating interface inhibiting fluid communication between the neck and the plenum.

16. The appliance of claim 1, comprising:
a controller operably coupled to the power delivery system the controller configured to command at the power delivery system to apply the potential difference between the conductive electrode and the filtration media.

17. The appliance of claim 1, wherein the conductive electrode is positioned outside of the housing.

18. The appliance of claim 17, wherein the filtration media is positioned at a housing internal volume formed at the housing and enclosed by a housing end cap positioned at a distal end relative to the fluid inlet opening and the fluid outlet opening.

19. The appliance of claim 1, wherein the filtration media comprises a porous structure comprising a conductive material.

20. A method for water filtration at an appliance, the method comprising:
positioning a conductive electrode in fluid communication with water upstream of a fluid inlet opening to a housing of a water filtration assembly, the conductive electrode positioned outside of the housing of the water filtration assembly;
electrically coupling the conductive electrode to a power delivery system;
positioning, in the housing of the water filtration assembly, a filtration media in serial fluid arrangement between the fluid inlet opening and a fluid outlet opening of the housing;
electrically coupling the filtration media to the power delivery system to form an electrolytic cell including the filtration media and the conductive electrode; and
selectively applying a potential difference between the conductive electrode forming a first electrode and the filtration media forming a second electrode.
